(19) United States
(12) Patent Application Publication
(10) Pub. No.: US 2015/0278717 A1
(43) Pub. Date: Oct. 1, 2015

(54) TASK REDUCTION IN DYNAMIC CASE MANAGEMENT

(71) Applicant: International Business Machines Corporation, Armonk, NY (US)

(72) Inventor: Ranjeeth Pasupathi, Tamilnadu (IN)

(73) Assignee: International Business Machines Corporation, Armonk, NY (US)

(21) Appl. No.: 14/228,296

(22) Filed: Mar. 28, 2014

(51) Int. Cl. G06Q 10/06

(52) U.S. Cl. CPC G06Q 10/06

(57) ABSTRACT

Embodiments of the present invention disclose a method, computer program product, and system for reducing repetitive tasks in case management. A computer initiates to display a searchable data field for relating a first case to a second case. The computer receives a first value for the searchable data field. The computer retrieves search results for the first value from a data store, wherein the data store comprises case related data. The computer initiates to display at least one search result from the data store in a selectable form. The computer receives a selection based, at least in part, on the at least one search result and the second case. The computer pins the first case to the second case based, at least in part, on the first value, wherein pinning the first case to the second case reduces a repetitive task.

### BACKGROUND

The present invention relates generally to the field of dynamic case management, and more particularly to relating a new case instance to an existing case instance for the purpose of task reduction.

Dynamic Case Management (DCM), also known as Adaptive or Advanced Case Management (ACM), is a method of automating case related work performed by case workers using software applications designed for industries, such as the insurance industry, which require the flexibility to manage dynamic and unstructured flows for processes. A case is a collection of information, including personal data, process flows, specialized tasks, business rules, and other case related services. DCM helps businesses more effectively and efficiently create or open cases, monitor their progress, drive cases to completion, and gain insights for decision making, risk assessment, and productivity management. Dynamic case management is more than business process management (BPM) or content management. DCM is a combination of both of these practices optimized for people-driven processes.

DCM provides the framework for a case worker to produce an acceptable resolution to a problem that may not follow a strict business process or set of rules, such as a dispute over a charge on a credit card statement. Case workers make ad hoc decisions on the next step in the resolution process. Each step may require a unique set of forms to be filled out, or a specialized task to be performed, and the DCM framework must allow for flexibility in the documentation of each. Examples of business processes utilizing dynamic case management solutions include: insurance claims, health care treatment plans, and credit card customer service. Some of the services offered by a DCM solution include: content management service, document capturing service, business monitoring service, structured and unstructured data analytics, and a case solution design service.

### SUMMARY

Embodiments of the present invention disclose a method, computer program product, and system for reducing repetitive tasks in case management. A computer initiates to display a searchable data field for relating a first case to a second case. The computer receives a first value for the searchable data field. The computer retrieves search results for the first value from a data store, wherein the data store comprises case related data. The computer initiates to display at least one search result from the data store in a selectable form. The computer receives a selection based, at least in part, on the at least one search result and the second case. The computer pins the first case to the second case based, at least in part, on the first value, wherein pinning the first case to the second case reduces a repetitive task.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting the operational steps of a case solution designer, on a client device within the distributed data processing environment of FIG. 1, for the purpose of customizing a case management application with the capability to relate a new case to an existing case, in accordance with an embodiment of the present invention.

FIG. 3 is a flowchart depicting the operational steps of a case solution client application, on a client device within the distributed data processing environment of FIG. 1, for the purpose of relating a new case to an existing case, in accordance with an embodiment of the present invention.

FIG. 4 depicts a block diagram of components of an exemplary computer system for implementing embodiments of the present invention.

### DETAILED DESCRIPTION

Dynamic Case Management (DCM) solutions which are currently on the market treat each customer case as a separate instance, and all the relevant tasks and activities are tied to that particular instance. Existing customer cases, either completed or in progress, are not taken into account in the creation of a new case instance, and may lead to a duplication of work thereby hindering the overall efficiency of the case solution system. Selected tasks of a case, such as verification of a customer address which may have been previously performed for a particular customer, are repeated over and over again for each new case instance pertaining to the same customer. Embodiments of the present invention provide for a method, referred to hereafter as “case pinning”, to relate a new case with an existing case for the purpose of reducing repetitive tasks. Implementation of case pinning in DCM solutions may be evident in the case solution client application used by the case worker, and the case solution design software which created and customized the said application.

Embodiments of the present invention recognize that current case structures and design solutions do not provide for relating one case to another case, or for copying a task from one case to another case. Each case is considered to be unique since the resulting outcome and the path taken to get to the outcome may be different in each case. Embodiments of the present invention may recognize that cases may be related to each other in the initial setup tasks or conditions, for example, identification of customer name, verification of customer address, and determination of customer credit rating. After initial tasks are related between a new case and an existing case, the new case may go forward with a different path for case resolution than the existing case has taken. Embodiments of the present invention recognize that reduction of repetitive tasks between related cases will improve response time of case resolution, improve customer satisfaction, and improve throughput of the service provider. Implementation of embodiments of the invention may take a variety of forms, and exemplary implementation details are discussed subsequently with reference to the figures.

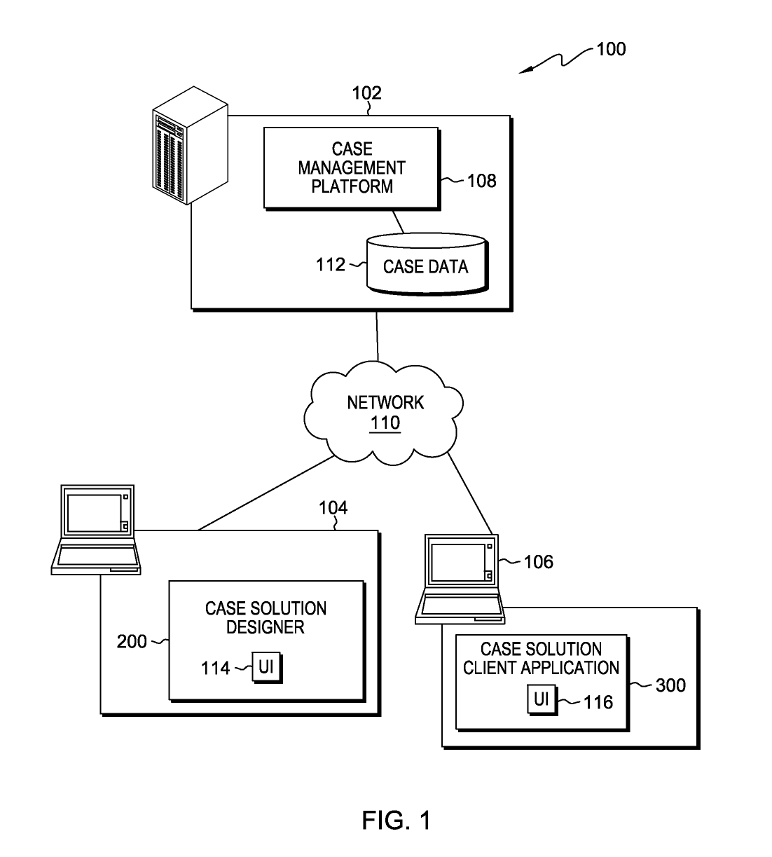

The present invention will now be described in detail with reference to the Figures. FIG. 1 is a functional block diagram illustrating a distributed data processing environment, generally designated 100, in accordance with an embodiment of the present invention. Distributed data processing environment 100 includes server computer 102, and client computers 104 and 106, interconnected over network 110. Distributed data processing environment 100 may include additional server computers, client computers, or other devices not shown.

Network 110 can be, for example, a local area network (LAN), a wide area network (WAN) such as the Internet, or a combination of the two, and can include wired, wireless, fiber optic, or any other connection known in the art. In general, network 110 can be any combination of connections and protocols that may support communications between server computer 102, and client computers 104 and 106, in accordance with a desired embodiment of the present invention.

Server computer 102 can be a server computer, an application server, a laptop computer, a tablet computer, a netbook computer, a personal computer (PC), a desktop computer, a personal digital assistant (PDA), a smart phone, or any programmable electronic device capable of communicating with client computers 104 and 106, via network 110. In certain embodiments, server computer 102 represents a computer system utilizing clustered computers and components that act as a single pool of seamless resources when accessed through network 110, as is common in data centers and with cloud computing applications. Server computer 102 may be a node in a distributed database management environment. In general, server computer 102 can be representative of any computing device or a combination of devices with access to case management platform 108, and case data 112, and is capable of executing case management platform 108.

Server computer 102 includes an instance of case management platform 108. In the depicted environment, case management platform 108 may be a suite of dynamic case management applications with capabilities including, but not limited to, content management service, document capturing service, business monitoring service, structured and unstructured data analytics, and a case solution design service. Case management platform 108 may provide application programming interfaces (API) that enable custom applications to connect to data repositories, such as case data 112, and issue commands for manipulating data repositories. In other embodiments, case management platform 108, and case data 112 may be on one computer, or more than one computer, and each item may be split into a plurality of parts or modules and spread across more than one computer. In any configuration, the following is maintained: case management platform 108 communicates with case data 112.

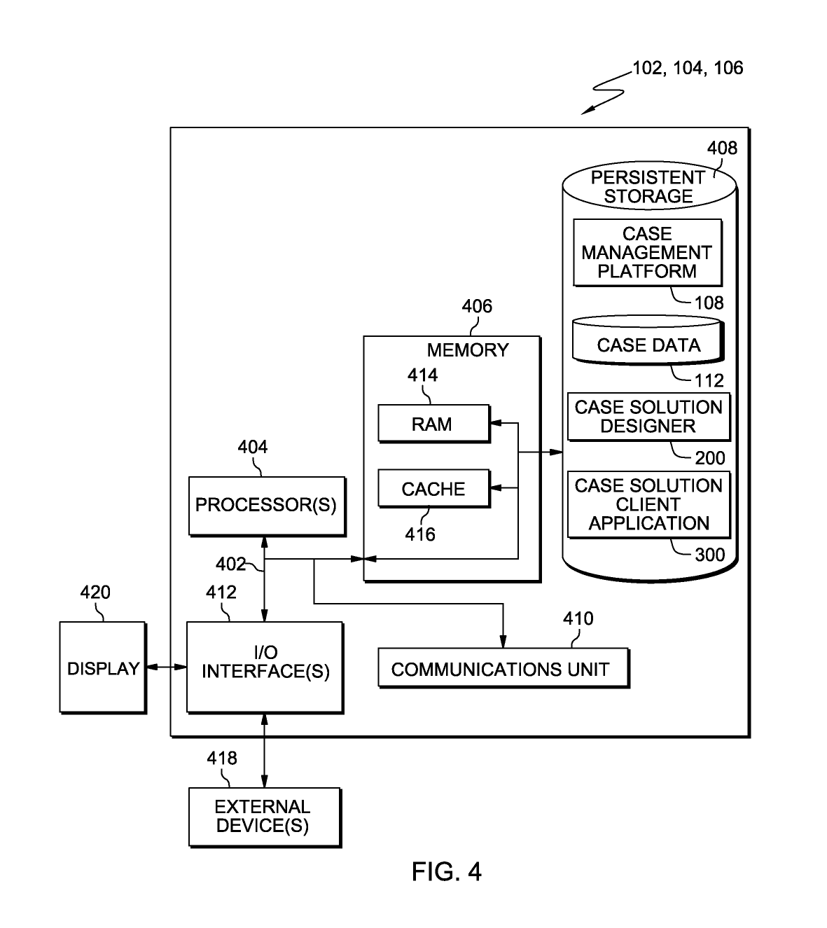

Server computer 102 includes an instance of case data 112. A case is a collection of information, including personal data, analytical assessments, process flows, case worker tasks, business rules, and case related services. Case data 112 is a repository for the storage of case related information including, but not limited to, databases, flat files, documents, reports, archives, or a combination thereof. Case data 112 can be implemented with any type of storage device, for example, persistent storage 408, which is capable of storing data that may be accessed and utilized by server computer 102, such as a database server, a hard disk drive, or flash memory. In other embodiments, case data 112 can represent multiple storage devices within server computer 102. Server computer 102 may include internal and external hardware components, as depicted and described in further detail with respect to FIG. 4.

In various embodiments of the present invention, client computers 104 and 106 can each respectively be a laptop computer, a tablet computer, an application server, a netbook computer, a personal computer (PC), a desktop computer, a personal digital assistant (PDA), a smartphone, or any programmable electronic device capable of communicating with server computer 102 and each other via network 110. Client computers 104 and 106 may each respectively be a node in a distributed database management environment. In general, client computers 104 and 106 can each respectively be representative of any computing device or a combination of devices with respective access to case solution designer 200, case solution client application 300, and are respectively capable of executing case solution designer 200 and case solution client application 300.

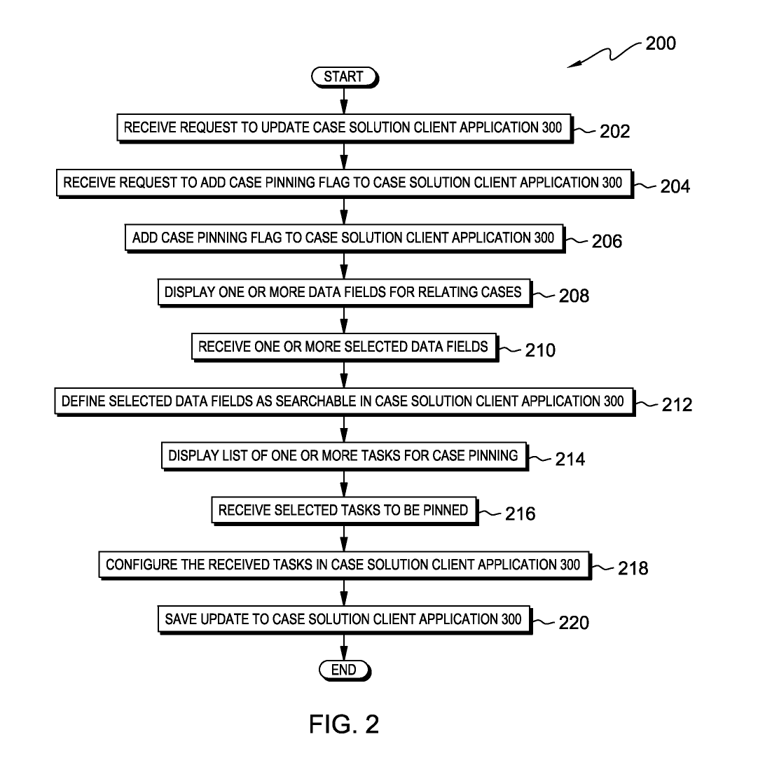

Client computer 104 includes an instance of case solution designer 200, which executes locally on client computer 104 and has the capability to customize case solution client application 300 on client computer 106, and case data 112 on server computer 102 via network 110. Case solution designer 200 on client computer 104 may add new data structures or customize existing structures in case data 112 on server computer 102 via network 110 for use by case solution client application 300 on client computer 106. Case solution designer 200 is an application allowing authorized users, such as case management solution designers, to create custom case management applications, such as case solution client application 300, for data integration against a repository of data on a server, such as case data 112 on server computer 102. Case solution designer 200 may provide the application programming interfaces (API) that enable custom applications, such as case solution client application 300, to connect to data repositories, such as case data 112, and issue commands for manipulating repositories, saving a developer from having to write complex code. In one embodiment, case solution designer 200 may use a graphical notation to construct case solutions with individual icons for case tasks. In another embodiment, case solution designer 200 may be an associated client application created by the vendor or developer of case management platform 108 for use in a server-client environment. Case solution designer 200 may be fully integrated with, partially integrated with, or be completely separate from case management platform 108. In the depicted environment, case solution designer 200 uses a user interface, such as UI 114, to receive user input, and to output responses to a user, such as an application designer or a case management solution designer. Case solution designer 200 is described further in FIG. 2.

Client computer 104 includes an instance of UI 114, which executes locally on the client computer. UI 114 may utilize a web page application, a command line processor, or any other graphical user interface (GUI). UI 114 includes components used to receive input from a user and transmit the input to case solution designer 200 residing on client computer 104. In an embodiment, UI 114 uses a combination of technologies and devices, such as device drivers, to provide a platform to enable users of client computer 104 to interact with case solution designer 200. In an embodiment, UI 114 receives input, such as dragging and dropping data icons onto a workspace using a physical input device, such as a keyboard or mouse, via a device driver that corresponds to the physical input device.

Client computer 106 includes an instance of case solution client application 300, which executes locally on the client computer and has the capability to communicate with case management platform 108 and case data 112 on server computer 102 via network 110. Case solution client application 300 sends information to, and receives information from, server computer 102 over network 110. Case solution client application 300 on client computer 106 may add or update information in case data 112 on server computer 102 via network 110. In the depicted environment, case solution client application 300 may be a custom written dynamic case management application to add, update, and retrieve customer information as well as add, update, and close tasks for each case within case data 112. Case solution client application 300 may be any program capable of connecting to case management platform 108 for the purpose of requesting case management platform 108 to perform some task.

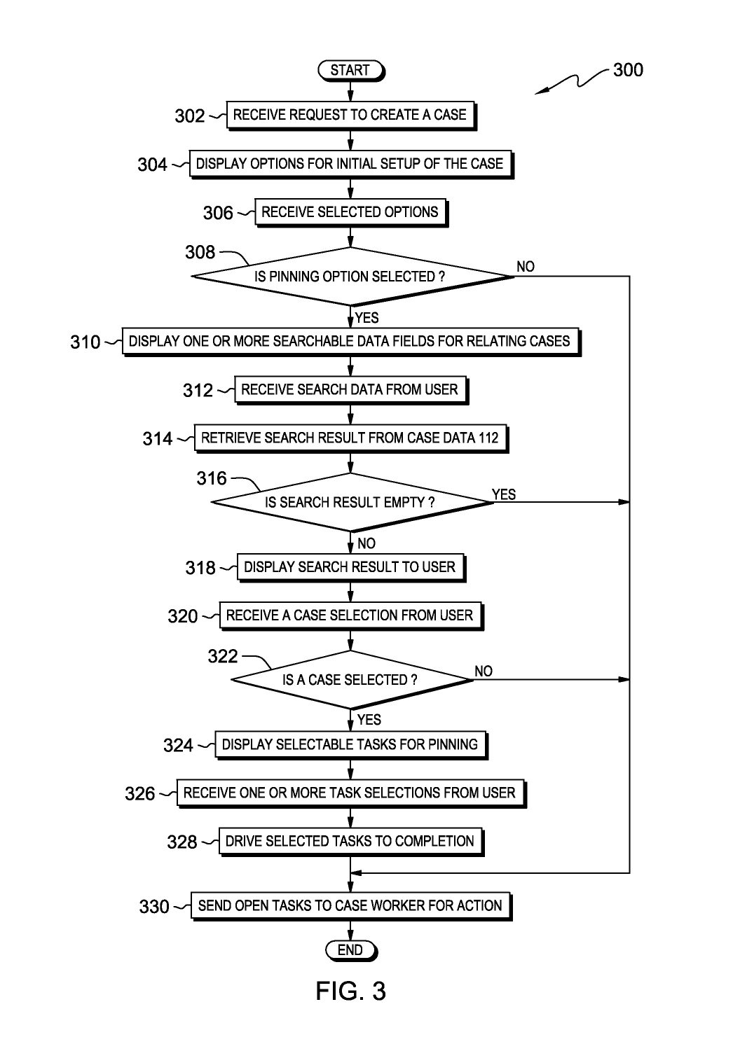

In some embodiments, case solution client application 300 may be an associated client application created by a vendor or developer of case management platform 108 for use in a server-client environment. In the depicted environment, case solution client application 300 uses a user interface, such as UI 116, to receive user input, and to output responses to a user. In various embodiments of the present invention, the user of case solution client application 300 is a case worker or knowledge worker. The case worker uses case solution client application 300 to achieve a goal without using a static or predefined workflow process. Case solution client application 300 provides flexibility to the user to define a dynamic workflow and to collaborate with other users to solve a case. Case solution client application 300 supports dynamic workflows, structured processes, or a combination of both. In alternate embodiments, case solution client application 300 may reside on server computer 102 or on client computer 104. Case solution client application 300 is described further in FIG. 3.

Client computer 106 includes an instance of UI 116, which executes locally on the client computer. UI 116 may utilize a web page application, a command line processor, or any other graphical user interface (GUI). UI 116 includes components used to receive input from a user and transmit the input to case solution client application 300 residing on client computer 106. In an embodiment, UI 116 uses a combination of technologies and devices, such as device drivers, to provide a platform to enable users of client computer 106 to interact with case solution client application 300. In an embodiment, UI 116 receives input, such as dragging and dropping data icons onto a case solution workspace using a physical input device, such as a touchpad or mouse, via a device driver that corresponds to the physical input device.

In other embodiments of the present invention, case management platform 108, case solution designer 200, case solution client application 300, and case data 112 may be on one computer, or more than one computer, and each item itself may be split into a plurality of parts or modules and spread across more than one computer. In any configuration, the following is maintained: case management platform 108, case solution designer 200, and case solution client application 300 may communicate with case data 112. Case management platform 108 may communicate with case solution designer 200, and case solution client application 300. Case solution designer 200 communicates with case solution client application 300.

In the illustrative embodiment of the present invention, case solution designer 200 allows an application designer to create or customize case solution client application 300 with the ability to relate one or more cases with an existing case, and reduce repetitive tasks for new related cases. In one embodiment of the present invention, the application designer may assign a flag to each task design to designate a case pinning option, which means attaching or relating one case item to another case item. On selecting the pinning flag, case solution designer 200 may graphically display a list of selectable data fields, and a list of selectable tasks within the overall case structure to be used for case pinning. The selected data field or fields will determine what criteria are used for comparing or relating two cases. The selected tasks will determine which tasks will be copied from the existing case to the new related case. The application designer will make the selections, and save the customized version of case solution client application 300 for use by case workers on client computer 106 via network 110.

In various embodiments of the present invention, case solution client application 300 allows a case worker to create a new case. Case solution client application 300 may automatically create initial tasks for the case, such as a documents verification task. In other embodiments, the case worker may manually select the initial task or tasks for the case from a predefined list of tasks. For example, a new case may have an initial task for documents verification in which the case worker may search on one of the selected data fields, such as customer name, with the intention of finding a related case by the same customer. If the same customer name is located, then the case worker may select to pin a new case of a customer to an existing case of the same customer. During pinning, the case worker may select which of the initial tasks from the predefined list may be copied or related to the new case, providing flexibility to the case worker as needed. Pinning creates a relationship between the first case and the second case allowing the sharing of selected case tasks, and reducing the need to execute the shared tasks more than once.

In one embodiment, if the new case is pinned to the existing case, then certain tasks selected by the designer will be copied from the existing case into the new case at runtime, and those tasks will be displayed as completed. In another embodiment, the related data may be linked between cases instead of copied. In yet another embodiment, the related data may not be copied or linked, but the task is listed as completed. The remaining incomplete tasks in the list will be sent to the original case worker or other case workers for action. An example of one of the selected tasks may be address verification. Case solution client application 300 allows the case worker to pin or relate the new case to the existing case, and skip the address verification step. By skipping or reducing tasks, the case worker is able to process more cases quickly and efficiently.

In another embodiment, the case worker may pin an existing case to another existing case. An existing task within an existing case may be used to pin an existing case to another existing case, if the task contains pinning criteria. Each time a new task is added to an existing case, a case worker may pin an existing case to another existing case, if the task is predefined with pinning criteria.

In some embodiments, case information may be copied or related to the new case if the information meets automated restrictions for age of information. For example, if an address is ten years old, then the address may no longer be valid, and the address verification step will need to be completed even though the step was originally listed as a task available to copy to a new case. One skilled in the art will recognize that many such restrictions may be imposed as part of data verification before copying existing data to the new case.

FIG. 2 is a flowchart depicting the operational steps of a case solution designer, on a client device within distributed data processing environment 100 of FIG. 1, for the purpose of customizing a case management application with the capability to relate a new case to an existing case, in accordance with an embodiment of the present invention. In one embodiment, case solution designer 200, running on client computer 104, allows a user to create or customize case solution client application 300 on client computer 106 via network 110.

In the illustrative embodiment of FIG. 2, case solution designer 200 allows a case solution developer to update case solution client application 300 to include case pinning. Case solution developer 200 receives at least one data field and at least one task from the case solution developer. Case solution developer 200 defines at least one data field to be searchable at runtime of case solution client application 300, when a case worker may search on the data field looking for an existing case which is related to a new case. Case solution designer 200 defines at least one task to be copied or related from the existing case to the new case. Case solution developer 200 saves the updates to case solution client application 300.

Case solution designer 200 receives a request to update case solution client application 300 (step 202). Case solution designer 200 provides a user interface, UI 114, which allows a user, such as a case solution developer, to design or customize case solution client application 300 and case data 112. Case solution designer 200 allows the case solution developer to define and update the data structures within case data 112 including, but not limited to, task structures, case structures, filed documents, content management, approval processes, collaboration methods, analytics, tracking history, and validation processes. In an embodiment of the present invention, a case solution developer selects a case solution design, for example, case solution client application 300, for customization, and case solution designer 200 receives the request to update case solution client application 300.

Case solution designer 200 receives a request to add a case pinning flag to case solution client application 300 (step 204). Case solution designer 200 receives a request from the case solution developer via UI 114 to add a case pinning flag to a case design structure within case solution client application 300. A case design structure may be a graphical representation of a case worker task including, but not limited to, a title, a list of data fields for data input by the case worker, variable names for storing data, definition of pre-condition properties, and various case flags. Case solution client application 300 may comprise one or more case design structures including case design templates. In the illustrated embodiment, only one such case design structure will be customized, but one skilled in the art will recognize that all case design structures may be customized in the same manner. Each case design structure may include several flags available for selection by the case solution developer, for example, task preconditions (values of property variables), execution start (automatic/manual), and case requirements (mandatory/optional). For each selected flag, case solution designer 200 presents the case solution developer with one or more fields to configure and fill in using UI 114. In an embodiment of the present invention, a flag for case pinning is available for selection by the case solution developer.

Case solution designer 200 adds a case pinning flag to case solution client application 300 (step 206). Responsive to receiving the request, case solution designer 200 adds the case pinning flag to the overall case solution design within case solution client application 300. Case solution designer 200 may use graphical notation and display an icon representing the pinning flag, may encode the pinning flag as a variable in the application software using a programming language, or a combination of both. In another embodiment, case solution designer 200 adds the case pinning flag to an individual task design within the case solution design based on the details of the request.

Case solution designer 200 displays one or more data fields for relating cases (step 208). Upon adding a case pinning flag, case solution designer 200 presents the case solution developer with one or more fields to be selected, and/or configured. In an embodiment of the present invention, case solution designer 200 displays a list of one or more data fields to be used for relating cases, including, but not limited to, customer name, company name, organization name, or case number. In another embodiment, the case solution developer may manually specify or search for a data field to include in the case solution design for case pinning.

Case solution designer 200 receives one or more selected data fields (step 210). The case solution developer selects one or more of the data fields, such as customer name, to be used for case pinning, and fills in any associated criteria, such as age of information restrictions, for the selected case solution design using UI 114. Case solution designer 200 receives the selected one or more data fields and any related criteria.

Case solution designer 200 defines the selected data fields as searchable in case solution client application 300 (step 212). Case solution designer 200 may use the received selected data fields to set variables in the case solution design recognized by case management platform 108, or to generate queries to allow case solution client application 300 to pull a list of existing cases from case data 112. The values for the data fields exist in case data 112, and allow a case worker, during runtime of case solution client application 300, to relate a new case to an existing case by searching on one or more of the displayed fields during case instance creation. One skilled in the art will recognize there may be many ways to designate selected data fields as searchable in an application.

Case solution designer 200 displays a list of one or more tasks for case pinning (step 214). Each case solution design may comprise one or more tasks within a case solution. Case solution designer 200 may display all defined tasks within the selected case design to the case solution developer with a method for selecting one or more individual tasks, such as check boxes. For example, in an insurance underwriting application, the following tasks may be included: address verification, credit history verification, claims history, documents review, underwriting, and approval. The case solution designer may select one or more of the listed tasks to be copied or linked from an existing case to a new case during case pinning.

Case solution designer 200 receives selected tasks to be pinned (step 216). When a case is pinned to an existing case, a sub-set of the tasks comprising the case solution design may be selected by the case solution developer for relating to the new case. Not all tasks will be selected, or else a new case instance would be unnecessary. In the example of an insurance underwriting application above, the case solution developer may select address verification, credit history verification, and claims history to be pinned, or related to a new case instance. Case solution designer 200 receives the selected tasks from the case solution developer through UI 114.

Case solution designer 200 configures the received tasks in case solution client application 300 (step 218). In the example above, the first three tasks were selected by the case solution developer to be pinned or related to a new case. Case solution designer 200 configures each received case task as relatable between the first case and the second case. Case solution designer 200 configures the received tasks by defining how to copy, or link to the case information residing in case data 112, which is related to the received tasks of an existing case. During runtime, case solution client application 300 may copy the case information into a new task for a new case, or the new task may simply link to the case information from an existing task of an existing related case. One skilled in the art will recognize that there may be many ways to link or relate shared information between two separate case instances.

Case solution designer 200 saves the update to case solution client application 300 (step 220). Case solution designer 200 saves all updates or changes to the case solution design and any updated tasks in a new version of case solution client application 300 on client computer 106 via network 110.

FIG. 3 is a flowchart depicting the operational steps of case solution client application 300, on a client device within distributed data processing environment 100 of FIG. 1, for the purpose of relating a new case to an existing case, in accordance with an embodiment of the present invention. Case solution client application 300 is a custom application for dynamic case management which may be designed using case solution designer 200 on client computer 104. Customization of case solution client application 300 to allow for case pinning of a new case to an existing case is previously discussed with regard to FIG. 2. In the illustrative example of FIG. 1, case management platform 108 on server computer 102 enables case solution client application 300 on client computer 106 to perform case management tasks by connecting with case data 112 via network 110. A person of ordinary skill in the art may recognize that users, such as case workers, of case solution client application 300 may go through proper validation of credentials before accessing case data 112, and making updates to the information stored therein.

Case solution client application 300 receives a request to create a case (step 302). In one embodiment of the present invention, case solution client application 300 receives a request from a case worker through UI 116 to create a new case instance based on a default case design template, or a case design template selected by the case worker. More than one type of case design template may exist within case solution client application 300 which may be selectable by the case worker when creating a new case. The selection of case design template is integrated into the request to create a case.

Case solution client application 300 displays options for initial setup of the case (step 304). Responsive to receiving the request to create a case, case solution client application 300 displays any predefined options for initial case setup to the user via UI 116. In one embodiment, a selectable option for case pinning may be displayed to the user. In other embodiments, the template may be predefined to use case pinning whenever possible, and a selectable option for case pinning may not be displayed to the user. In the latter case, the option for case pinning is evident in the flag settings received by case solution client application 300.

Case solution client application 300 receives selected options (step 306). In one embodiment, case solution client application 300 receives selections for options from the user via UI 116. In another embodiment, case solution client application 300 automatically receives certain options, such as flag settings, based on the case design template created by case solution designer 200. Case solution client application 300 determines which options were selected, such as the option for case pinning.

Case solution client application 300 determines if the pinning option is selected (decision block 308). Other options may be displayed, for example execution type (manual or automatic), but for the purpose of the illustration, only the case pinning option will be discussed. If case solution client application 300 determines that the pinning option is not selected (no branch, decision block 308), then case solution client application 300 sends open tasks to case worker for action (step 330).

If case solution client application 300 determines that the pinning option is selected (yes branch, decision block 308), then case solution client application 300 displays one or more searchable data fields for relating cases (step 310). If a case solution design or task design allows case pinning, then case solution client application 300 uses one or more data fields defined within case data 112 to relate cases during runtime of case solution client application 300. Case solution client application 300 displays one or more data fields to the user via UI 116. For example, each displayed field may allow the user to input a search value via UI 116. In other embodiments, case solution client application 300 may display the data fields as a drop down list of selectable values created from actual data within case data 112.

Case solution client application 300 receives search data from user (step 312). The user selects a search value from a list, or inputs a search value which is to be used as search data for at least one of the displayed fields. Case solution client application 300 receives the user input from at least one of the searchable data fields via UI 116.

Case solution client application 300 retrieves search result from case data 112 (step 314). Case solution client application 300 may format the received search data into a query which retrieves additional case information from case data 112 based, at least in part, on the received search data. Case solution client application 300 may use resources of case management platform 108 on server computer 102 to perform the query on case data 112. Case solution client application 300 receives a result of the query from case data 112

Case solution client application 300 determines if the search result is empty (decision block 316). If case solution client application 300 determines that the search result is empty (yes branch, decision block 316), then case solution client application 300 sends open tasks to case worker for action (step 330). If the search result is empty, then no match was found for the search value, and the case cannot be pinned to another existing case.

If case solution client application 300 determines that the search result is not empty (no branch, decision block 316), then case solution client application 300 displays the search result to the user (step 318). Case solution client application 300 formats any case related values in the retrieved search result into a list of one or more selectable case values for display to the user via UI 116. In some embodiments, case solution client application 300 may display an additional option for a null value, giving the user the ability to prevent case pinning.

Case solution client application 300 receives a case selection from the user (step 320). The user makes a selection from the displayed list of one or more case values (displayed in step 318). Case solution client application 300 receives the case selection from the user via UI 116.

Case solution client application 300 determines if a case is selected (decision block 322). If the user selected a value from the displayed list (in step 320), then the value is associated with an existing case. For example, if the user selected the name John Doe from a displayed list of customers, then the case associated with John Doe would be selected for case pinning. If case solution client application 300 determines that a case is not selected (no branch, decision block 322), then case solution client application 300 sends open tasks to case worker for action (step 330). Even though the search result is not empty, there may be situations when a case worker decides not to allow case pinning. In that case, one of the displayed selections may have been a null value allowing the case worker to prevent case pinning. The details of the retrieved additional case information in the search result may indicate to the case worker that the cases do not match well enough for case pinning to be of value.

If case solution client application 300 determines that a case is selected (yes branch, decision block 322), then case solution client application 300 displays selectable tasks for case pinning (step 324). In one embodiment, case solution client application 300 may automatically create a list of one or more tasks based, at least in part, on the selected or default case design template. In another embodiment, the case worker manually selects from a predefined list of available tasks, the initial task or tasks to be added to the new case. In the illustrative embodiment, case solution client application 300 displays a list of selectable tasks from an existing case which may be pinned to the new case. The user may select one or more tasks to be pinned to the new case. In the example of an insurance underwriting application from FIG. 2, the developer selected address verification, credit history verification, and claims history to be pinned, or related to a new case. In the example at runtime, case solution client application 300 would display the three tasks of address verification, credit history verification, and claims history in a list where each item is selectable.

Case solution client application 300 receives one or more task selections from the user (step 326). Case solution client application 300 receives those tasks selected by the user from the displayed list via UI 116. The user may select one task, all the displayed tasks, or some sub-set of the displayed tasks.

Case solution client application 300 drives selected tasks to completion (step 328). Case solution client application 300 processes the selected tasks by copying, or linking to the case information residing in case data 112 for each selected task from the existing case to a new task in the new case. The information may be copied into a new task for the new case, or the task may simply link to the information from the existing task of the existing related case. One skilled in the art will recognize that there may be many ways to link or relate shared information between two separate case instances. In one embodiment, case solution client application 300 creates each selected task for the new case, fills in the replicate information from the existing case, and sets the status of the new task to a completed state. In this way, case solution client application 300 drives each selected task to completion. Case solution client application 300 may query case data 112 for the necessary information to fill in each selected task, or the information may have been retrieved earlier as part of the search result from step 314. In some embodiments, case solution client application 300 may create the non-selected tasks from the list of selectable tasks as empty tasks in the new case with a status of not completed.

Case solution client application 300 sends open tasks to case worker for action (step 330). After the initial tasks selected by the user for case pinning are listed as completed, case solution client application 300 will save the new case and associated new tasks. In one embodiment, case solution client application 300 will send all tasks not set to completion to one or more case workers for action. In other embodiments, case solution client application 300 will send the next task not set to completion to the case worker for action.

At this point, a new case has been created, pinned to an existing case, and stored in case data 112. The developer of case solution client application 300 may have included various other tasks to be performed after case pinning is completed, or the case worker may perform one or more of the following: continue on to add another task to the current case, work on another existing case, create a new case, or shutdown.

In an alternate embodiment, case solution client application 300 may perform a similar flow as above when a case worker selects to update an existing case that is still processing any of the initial tasks selectable for case pinning.

FIG. 4 depicts a block diagram of respective components of server computer 102, and client computers 104, and 106, in accordance with an illustrative embodiment of the present invention. It may be appreciated that FIG. 4 provides only an illustration of one implementation and does not imply any limitations with regard to the environments in which different embodiments may be implemented. Many modifications to the depicted environment may be made.

Server computer 102, and client computers 104, and 106, each include respective communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Case management platform 108, case data 112, case solution designer 200, and case solution client application 300 are stored in respective persistent storage 408 for execution and/or access by one or more of the further respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of server computer 102, and client computers 104, and 106. In these examples, communications unit 410 includes one or more network interface cards. Communications unit 410 may provide communications through the use of either or both physical and wireless communications links. Case management platform 108, case data 112, case solution designer 200, and case solution client application 300 may be downloaded to respective persistent storage 408 through communications unit 410.

I/O interface(s) 412 allows for input and output of data with other devices that may be connected to server computer 102, and client computers 104, and 106. For example, I/O interface 412 may provide a connection to external device(s) 418 such as a keyboard, a keypad, a touch screen, and/or some other suitable input device. External device(s) 418 can also include portable computer readable storage media such as, for example, thumb drives, portable optical or magnetic disks, and memory cards. Software and data used to practice embodiments of the present invention, e.g., case management platform 108, case data 112, case solution designer 200, and case solution client application 300, can be stored on such portable computer readable storage media and can be loaded onto respective persistent storage 408 via I/O interface(s) 412. I/O interface(s) 412 also connect to a display 420.

Display 420 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1-7. (canceled)

8. A computer program product for reducing repetitive tasks in case management, the computer program product comprising:
a computer readable storage medium and program instructions stored on the computer readable storage medium, the program instructions comprising:
program instructions to initiate to display a searchable data field for relating a first case to a second case;
program instructions to receive a first value for the searchable data field;
program instructions to retrieve search results for the first value from a data store, wherein the data store comprises case related data;
program instructions to initiate to display at least one search result from the data store in a selectable form;
program instructions to receive a selection based, at least in part, on the at least one search result and the second case; and
program instructions to pin the first case to the second case based, at least in part, on the first value, wherein pinning the first case to the second case reduces a repetitive task.

9. The computer program product of claim 8, wherein pinning the first case to the second case reduces a repetitive task comprises:
program instructions to initiate to display a case task that is selectable;
program instructions to receive selection of the case task; and
program instructions to set a status flag of the case task as complete.

10. The computer program product of claim 8, wherein pinning the first case to the second case reduces a repetitive task comprises:
program instructions to set a status flag of an automatically selected case task as complete.

11. The computer program product of claim 8, further comprising:
program instructions to initiate to create a first case in a case management system;
program instructions to determine if a pinning option is selected;
responsive to determining that a pinning option is selected, program instructions to pin a first case to a second case, wherein pinning creates a relationship between the first case and the second case allowing sharing of selected case tasks, and reducing a need to execute a shared selected case task more than once.

12. The computer program product of claim 8, further comprising:
program instructions to receive a request to insert a pinning flag into a case structure of a case management application, wherein the pinning flag indicates a capability to pin a first case to a second case;
responsive to receiving a request to insert a pinning flag into the case structure of the case management application, program instructions to insert the pinning flag into the case structure of the case management application;
program instructions to receive a selection of a data field of the case structure;
program instructions to define the received data field to be searchable, wherein the value of the data field may reside in the data store of case related data;
program instructions to receive a case task of the case structure; and
program instructions to configure the received case task of the case structure as relatable between the first case and the second case.

13. The computer program product of claim 12, wherein configuring the received case task of the case structure as relatable comprises:
program instructions to configure a status flag for the received case task of the case structure to be set as complete based, at least in part, on the pinning flag.

14. The computer program product of claim 12, wherein configuring the received case task of the case structure as relatable comprises:
program instructions to configure a status flag for the received case task of the case structure to be set as complete based, at least in part, on user input of a selection of a case task that is selectable.

15. A computer system for reducing repetitive tasks in case management, the computer system comprising:
one or more computer processors;
one or more computer readable storage media;
program instructions stored on the computer readable storage media for execution by at least one of the one or more processors, the program instructions comprising:
program instructions to initiate to display a searchable data field for relating a first case to a second case;
program instructions to receive a first value for the searchable data field;
program instructions to retrieve search results for the first value from a data store, wherein the data store comprises case related data;
program instructions to initiate to display at least one search result from the data store in a selectable form;
program instructions to receive a selection based, at least in part, on the at least one search result and the second case; and
program instructions to pin the first case to the second case based, at least in part, on the first value, wherein pinning the first case to the second case reduces a repetitive task.

16. The computer system of claim 15, wherein pinning the first case to the second case reduces a repetitive task comprises:
program instructions to initiate to display a case task that is selectable;
program instructions to receive selection of the case task; and
program instructions to set a status flag of the case task as complete.

17. The computer system of claim 15, wherein pinning the first case to the second case reduces a repetitive task comprises:
program instructions to set a status flag of an automatically selected case task as complete.

18. The computer system of claim 15, further comprising:
program instructions to receive a request to insert a pinning flag into a case structure of a case management application, wherein the pinning flag indicates a capability to pin a first case to a second case;
responsive to receiving a request to insert a pinning flag into the case structure of the case management application, program instructions to insert the pinning flag into the case structure of the case management application;
program instructions to receive a selection of a data field of the case structure;
program instructions to define the received data field to be searchable, wherein the value of the data field may reside in the data store of case related data;
program instructions to receive a case task of the case structure; and
program instructions to configure the received case task of the case structure as relatable between the first case and the second case.

19. The computer system of claim 18, wherein configuring the received case task of the case structure as relatable comprises:
program instructions to configure a status flag for the received case task of the case structure to be set as complete based, at least in part, on the pinning flag.

20. The computer system of claim 18, wherein configuring the received case task of the case structure as relatable comprises:
program instructions to configure a status flag for the received case task of the case structure to be set as complete based, at least in part, on user input of a selection of a case task that is selectable.
